(19) United States
(12) Patent Application Publication
(10) Pub. No.: US 2022/0189333 A1
(43) Pub. Date: Jun. 16, 2022

(54) METHOD OF GENERATING BOOK DATABASE FOR READING EVALUATION

(71) Applicant: iPortfolio Inc., Seoul (KR)

(72) Inventors: Yong Min Yim, Seoul (KR); Sejin Yang, Seoul (KR); Hanee Park, Seoul (KR)

(73) Assignee: iPortfolio Inc., Seoul (KR)

(21) Appl. No.: 17/153,627

(22) Filed: Jan. 20, 2021

(30) Foreign Application Priority Data
Dec. 11, 2020 (KR) 10-2020-0173221
Dec. 15, 2020 (KR) 10-2020-0175258

(51) Int. Cl. G09B 17/00; G06F 40/295; G06F 40/253; G06F 40/166; G06K 9/46; G10L 15/22; G10L 15/10; G06K 9/00; G10L 15/30; G09B 7/02; G06F 16/31

(52) U.S. Cl. CPC G09B 17/003; G06F 40/295; G06F 40/253; G06F 40/166; G06K 9/46; G10L 15/22; G09B 19/06; G06K 9/00456; G10L 15/30; G09B 7/02; G06F 16/316; G06K 2209/01; G10L 15/10

(57) ABSTRACT

Provided is a method of generating a book database for reading evaluation of a user, a method of determining a type of a user utterance using a book database, and a method of generating a conversation sentence using a book database, the method of generating a book database for reading evaluation of a user including the steps of: dividing the entire text included in the received book data into units of sentences; assigning the sentences with sentence identifiers (IDs); assigning the words with word IDs; generating and storing a table in which the word ID and the sentence ID match with each other, the table referred to as a word-sentence matching table; and calculating a weight of each of the words using the number of the sentences including the word and storing the weights of the respective words.

### CROSS-REFERENCE TO RELATED APPLICATION

This application claims priority to and the benefit of Korean Patent Application Nos. 2020-0173221, filed on 2020-0175258, the disclosures of which are incorporated herein by reference in its entirety.

### BACKGROUND

### 1. Field of the Invention

The disclosure relates to a method of generating a book database for reading evaluation.

### 2. Discussion of Related Art

The following descriptions merely provide background information relevant to present embodiments rather than constituting the related art.

For learners who are learning a foreign language rather than their native language, reading books in a foreign language is very helpful. Accordingly, there has been development of various services for digitizing foreign language books and providing a learner with the digitized foreign language books. In addition to simply providing digitized foreign language books, a service for checking whether a learner has correctly read and understood foreign language books, that is, a reading evaluation service, is also gaining a lot of interest.

The reading evaluation service operates in a way to generate a question database (DB) related to the contents of the book and a correct answer DB for the corresponding questions, and according to whether a user's answer to a question matches a prepared correct answer DB, determine whether the user has read the book or evaluate the understanding of the contents of the book. Since the related art treats the answer as being correct or wrong depending on whether the answer of the user matches the correct answer DB or whether words included in the answer of the user match keywords included in the correct answer DB, the user is required to provide highly limited answers.

On the other hand, when a learner answers through speech, the answer may not be treated as a correct answer due to inaccuracy of pronunciation in a process of converting the speech into a sentence (Speech-To-Text, STT). In particular, the younger the learner (e.g., learners aged 3 to 13), the higher the likelihood of existence of inaccuracies in pronunciation in saying correct answers and errors in grammar in sentences. In this case, even when the learner has read the book and understands the contents correctly, the answer is treated as a wrong answer, and the learner may lose interest.

Therefore, in terms of determining whether a user has read a book or evaluating the understanding of content of the book, there is a need to construct a question DB and a correct answer DB that may sufficiently reflect the contents of the book.

### RELATED ART DOCUMENT

### Patent Document

Korean Laid-open Patent Publication No. 10-2005-0077244 (Aug. 1, 2005)

### SUMMARY OF THE INVENTION

The disclosure is directed to providing a method of generating a book database for evaluating user's reading, a method of determining the type of an utterance of a user using a book database, and a method of generating a conversation sentence using a book database.

The technical objectives of the disclosure are not limited to the above, and other objectives may become apparent to those of ordinary skill in the art based on the following descriptions.

According to an aspect of the disclosure, there is provided a method of generating a book database for reading evaluation, the method, executed by a processor, including the steps of: (a) receiving book data of a book including text; (b) dividing the entire text included in the book into units of sentences; (c) assigning the sentences with sentence identifiers (IDs) and storing the sentences assigned with the sentence IDs; (e) dividing words included in each of the sentences assigned with the sentence IDs; (f) assigning the words with word IDs and storing the words assigned with the word IDs such that the same words included in the book are assigned with the same word ID; (g) generating and storing a table in which the word ID and the sentence ID match with each other, the table referred to as a word-sentence matching table; and (h) calculating a weight of each of the words using the number of the sentences including the word and storing the weights of the respective words.

The weight of each of the words may increase proportionally as the number of the sentences including the word increases.

The weights of the words may be provided such that a largest weight is twice a smallest weight.

The step (h) may be a step of calculating the weight of each of the words through the following Equation:

$$weight = ( \frac{number of sentences including word}{\begin{matrix}number of sentences including \\ word used in most sentences\end{matrix}} ) + 1 \qquad [ Equation ]$$

The step (e) may be a step of excluding an article in each of the sentences.

According to another aspect of the disclosure, there is provided a method of determining a type of a user utterance using a book database, the method including: (a) storing the book database generated a method of generating a book database; (b) converting speech input by a user into a text; (c) selecting a word ID that matches with a word included in the converted text; (d) selecting a sentence ID including the selected word ID using the word-sentence matching table; (e) calculating a similarity between each word included in a sentence corresponding to the selected sentence ID and each word included in the converted text; and (f) determining that the speech input by the user has a content based on the book when the calculated similarity is greater than or equal to a preset reference value.

The step (e) may be a step of calculating the similarity to reflect the weight of each word included in the sentence.

The step (e) may be a step of calculating the similarity in comparison to the number of words included in the converted text.

The step (e) may be a step of calculating the similarity according to the following Equation:

$$similarity = \frac{\begin{matrix}\{ {\sum }_{i = 1}^{k} ( {i}^{th} word largest similariy value ) \times \\ ( {i}^{th} word weight ) \} \times ( number of words in utterace )\end{matrix}}{100} \qquad [ Equation ]$$

wherein i denotes an order of the words included in the converted text, and k denotes a total number of the words included in the converted text.

The preset reference value may be 70.

The step (b) may include: (b-1) extracting information about a part of speech and information about a named entity of the words included in each of the sentences; (b-2) removing sentences corresponding to a preset exclusion sentence criterion; (b-3) removing words corresponding to a preset exclusion word criterion in sentences remaining after removing the sentences; (b-4) classifying characters in words remaining after removing the words in the remaining sentences according to a preset criterion; and (b-5) storing a story sentence through the final remaining sentence.

The step (b-1) may include extracting the information related to the named entity after replacing a pronoun with a proper noun through a coreference resolution.

The step (b-2) may be a step of removing a sentence including a verb or an auxiliary verb indicating an opinion or a possibility.

The step (b-2) may be a step of removing a sentence including a word indicating an emotion.

The step (b-2) may be a step of removing, among two or more sentences having the same subject and the same verb and having a sentence-to-sentence similarity that is greater than or equal to a preset reference similarity value, a remaining sentence except for one sentence.

The step (b-3) may be a step of removing a word that is a part of speech corresponding to a conjunction, a preposition, an interjection, an adverb, or an adjective.

The step (b-4) may be a step of, when a name identified through the named entity information appears in the final remaining sentences a preset number of times or more, setting the named entity as a character.

The book data may be image data including a text and an illustration. In this case, the step (a) may further include: (a-1) acquiring text information and text position information through optical character recognition (OCR) analysis for each page; (a-2) excluding text which is not a body text using at least one of a text position, a recognition accuracy, and a text size; and (a-3) dividing the body text into paragraphs using information about the position or size of the body text.

The step (a) may further include: (a-1-1) setting, in a region where the text in the page is located, an area that does not overlap a text area and has a color contrasting with a background color, as an illustration area; and (a-1-2) executing an object recognition algorithm on the set illustration area to store an object name of the illustration.

The step (a-1-1) may include, in response to a plurality of illustration areas being set, setting illustrations that are connectable to each other as one illustration.

The step (a) may further include: (a-1-3) determining a relevance between the paragraph and the illustration included in each page; and (a-1-4) in response to the relevance between the illustration and the paragraph being satisfying a preset condition, storing the sentence or word included in the paragraph to match with the illustration.

The step (a-1-3) may be a step of determining the relevance according to a proximity of the illustration area and a sentence area.

The step (a-1-3) may be a step of determining the relevance according to whether the illustration area and the sentence area have edges parallel to each other.

The step (a-1-3) may be a step of determining the relevance according to whether the sentence includes a word that matches or approximates the object name of the illustration.

The step (b-2) may be a step of determining that the matched sentence does not correspond to the exclusion sentence criterion.

According to another aspect of the disclosure, there is provided a method of generating a conversation sentence using a book database, the method, executed by a processor, including the steps of: (a) storing book databases generated for respective books according to the method of generating a book database; (b) setting a last book read by a user among all the books as a reference book; (c) converting speech input by a user into text; (d) determining whether the converted text has a content based on the reference book according to the steps (c) to (f) of the method of generating a book database; and (e) when the converted text has a content based on the reference book, outputting a conversation sentence related to the reference book as speech and, when the converted text has a content based on the remaining book except for the reference book among all the books, outputting a conversation sentence related to the remaining book as speech.

The speech input by the user in the step (c) may be an answer to a question for reading evaluation of the reference book, and the step (e) may include, when the converted text has a content based on the reference book, outputting a result indicating whether the answer to the question for reading evaluation of the reference book is a correct answer, or another question for reading evaluation of the reference book as speech.

The speech input by the user in the step (c) may be an answer to a question for reading evaluation of the reference book, and the step (e) may include, when the converted text has a content based on the remaining book except for the reference book among all the books, treating the answer to the question for reading evaluation of the reference book as a wrong answer, and outputting another question for reading evaluation of the reference book as speech.

The speech input by the user in the step (c) may be an answer to a question for reading evaluation of the reference book, and the step (e) may include, when the converted text has a content based on the remaining book except for the reference book among all the books and all the questions for the reading evaluation of the reference book are output, outputting speech that suggests reading the remaining book.

The step (e) may further include, when the converted text does not correspond to a content based on all the books including the reference book, generating a sentence corresponding to the converted text through a preset website and outputting the generated sentence as speech.

Other specific details of the disclosure are included in the specification and the accompanying drawings.

### BRIEF DESCRIPTION OF THE DRAWINGS

The above and other objects, features and advantages of the disclosure will become more apparent to those of ordinary skill in the art by describing exemplary embodiments thereof in detail with reference to the accompanying drawings, in which:

FIG. 1 is a schematic flowchart showing a method of generating a book database according to the disclosure;

FIG. 2 is a schematic flowchart showing a method of determining the type of a user utterance according to the disclosure;

FIG. 3 is an exemplary diagram illustrating an example of comparing sentence S0001 with a user utterance;

FIG. 4 is an exemplary diagram illustrating an example of comparing sentence S0002 with a user utterance;

FIG. 5 is an exemplary diagram illustrating an example opposed to that shown in FIGS. 3 and 4;

FIG. 6 is a schematic flowchart showing a method of generating a conversation sentence according to the disclosure;

FIG. 7 is an exemplary diagram illustrating a reference book;

FIG. 8 is a schematic flowchart showing a method of generating a book database according to an embodiment of the disclosure;

FIG. 9 is a schematic flowchart showing a method of generating a book database according to another embodiment of the disclosure; and

FIG. 10A shows reference diagrams for describing recognition of paragraphs and illustrations

FIG. 10B shows reference diagrams for describing recognition of paragraphs and illustrations

FIG. 10C shows reference diagrams for describing recognition of paragraphs and illustrations

### DETAILED DESCRIPTION OF EXEMPLARY EMBODIMENTS

Hereinafter, the above advantages and features of the disclosure and ways of achieving them will become readily apparent with reference to descriptions of the following detailed embodiments in conjunction with the accompanying drawings. However, the disclosure is not limited to such embodiments and may be embodied in various forms. The embodiments to be described below are provided only to assist those of ordinary skill in the art in fully understanding the scope of the disclosure, and the scope of the disclosure is defined only by the appended claims.

Terms used herein are used to aid in the explanation and understanding of the embodiments and are not intended to limit the scope and spirit of the disclosure. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

In connection with assigning reference numerals to elements in the drawings, the same reference numerals are used to designate the same elements through the whole specification, and the term “and/or” includes any one or combinations of the associated listed items. It should be understood that, although the terms “first,” “second,” etc. may be used herein to describe various elements, these elements are not limited by these terms. These terms are only used to distinguish one element from another. For example, a first element could be termed a second element without departing from the scope of the disclosure.

Unless otherwise defined, all terms (including technical and scientific terms) used herein have the same meaning as commonly understood by one of ordinary skill in the art to which this invention belongs. It should be further understood that terms, such as those defined in commonly used dictionaries, should not be interpreted in an idealized or overly formal sense unless expressly so defined herein.

Hereinafter, embodiments of the disclosure will be described in detail with reference to the accompanying drawings. On the other hand, a method of generating a book database for reading evaluation of a user, a method of determining the type of a user utterance using a book database, and a method of generating a conversation sentence using a book database according to the disclosure may be executed in an information processing terminal, such as a computer, by a processor. Therefore, in the following description, the agent performing each step is the processor.

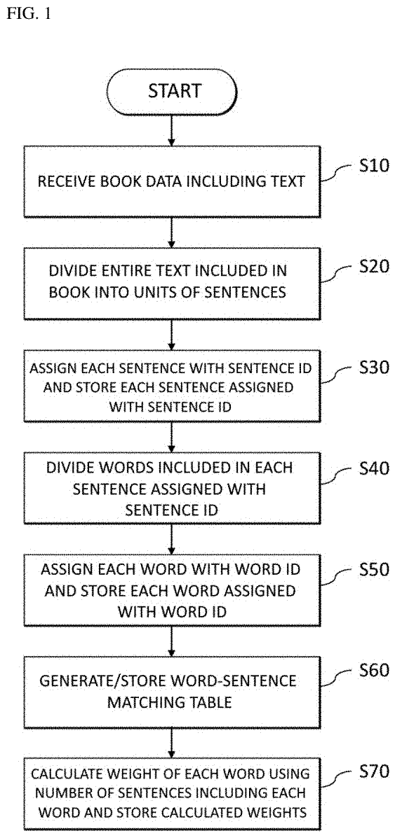

FIG. 1 is a schematic flowchart showing a method of generating a book database according to the disclosure.

Referring to FIG. 1, in the method of generating a book database for reading evaluation according to the disclosure, first, in step S10, the processor may receive book data including a text. The method of generating the book database illustrated in FIG. 1 is a method of processing one book. However, the method of generating a book database according to the disclosure does not end with processing for only one book and may be executed for a plurality of books. For example, in response to a complete collection of one hundred English books for young users, the “book data” refers to content of one of the hundred books.

In step S20, the processor may divide the entire text included in the book into units of sentences. Further, in step S30, the processor may assign the sentences with sentence IDs and store the sentences assigned with the sentence IDs.

In step S40, the processor may divide words included in each of the sentences assigned with the sentence IDs. In step S50, the processor may assign the words with word IDs and store the words assigned with the word IDs. In this case, the same words included in the book have the same word ID.

In step S60, the processor may generate a table in which the word ID and the sentence ID match with each other (hereinafter referred to as “word-sentence matching table”) and store the generated table.

In step S70, the processor may calculate the weight of each of the words using the number of sentences including the word and store the weights of the respective words.

Hereinafter, the method of generating a book database according to the disclosure will be described once again through example sentences and words. As an example, it is assumed that a text included in a book contains two sentences: “The boy is on the playground. The boy is Tom.” (S10).

The two sentences may be divided into units of sentences and a sentence ID may be assigned to each sentence as shown in Table 1 below (S20 and S30).

TABLE 1

| Sentence ID | Sentence |
|---|---|
| S001 | The boy is on the playground. |
| S002 | The boy is Tom. |

The processor may divide words included in each sentence and assign each word with a word ID as shown in Table 2 below (S40 and S50). In this case, the word IDs are assigned such that the same words included in the book have the same word ID. Meanwhile, the processor may assign the words with the word IDs and store the words assigned with the word IDs by excluding articles (e.g., a, an, the) from each sentence.

TABLE 2

| Word ID | Word | Weight |
|---|---|---|
| W001 | boy | 2 |
| W002 | Playground | 1 |
| W003 | Tom | 1 |

In addition, the processor may generate and store the word-sentence matching table as shown in Table 3 below (S60). In addition, the processor may calculate and store the weight of each word as shown in Table 2 above using the number of sentences including each word (S70).

TABLE 3

| Word ID | Sentence ID |
|---|---|
| W001 | S001 |
| W001 | S002 |
| W002 | S001 |
| W003 | S002 |

The weight of each word is a value that may increase proportionally as the number of sentences including each word increases. According to an embodiment of the disclosure, the weights of the words may be provided such that the largest weight value is twice the smallest weight value.

In detail, in step S70, the processor may calculate the weight of each word through Equation 1 below.

$$weight = ( \frac{number of sentences including word}{\begin{matrix}number of sentences including \\ word used in most sentences\end{matrix}} ) + 1 \qquad [ Equation 1 ]$$

In Equation 1, the word used in the most sentences and the word used in the least sentences may be assigned with a weight “2” and a weight “1,” respectively, and the remaining words may have a weight calculated through Equation 1 above. The reason the smallest weight value is set to “1” is to prevent a decrease in the similarity of sentences due to the weight when determining the type of a user utterance below.

When the method of generating a book database according to the disclosure is completed for one book, the method may be repeatedly executed for the remaining books. Accordingly, a database, in which the relationship between words and sentences for a plurality of books is arranged, is constructed. Reading evaluation of a user may be performed using the database constructed as above. The user's reading evaluation may be evaluated on the basis of whether the user has read a specific book and correctly understands the contents of the specific book. For example, the user's reading evaluation may be performed by providing a user with a question about a character in the specific book and checking an answer to the question. For another example, the reading evaluation may be performed in a way to check, when a user describes a plot of a specific book, the degree to which the plot matches the content of the specific book.

In this process, the answer of the user may match the content of the specific book but may not be provided in a perfect sentence without grammatical errors. In addition, the answer of the user may be slightly different from the content of the specific book but may be provided at a level at which there is no difficulty in identifying the content of the specific book. In other words, the answer of the user may not be an answer that requires re-reading of the specific book but may be an answer having an error small enough to naturally move on to the next question or the next book.

On the other hand, even when the reading evaluation is not a memorization evaluation, the answer of the user may be evaluated only based on whether the answer matches texts, letters, or words included in the book, and in this case, the user may be evaluated at a level that the user needs to read the book again even when the user has sufficiently understood the contents of the book. Accordingly, there is a need for a method of determining whether a user utterance is an utterance based on the contents of a specific book.

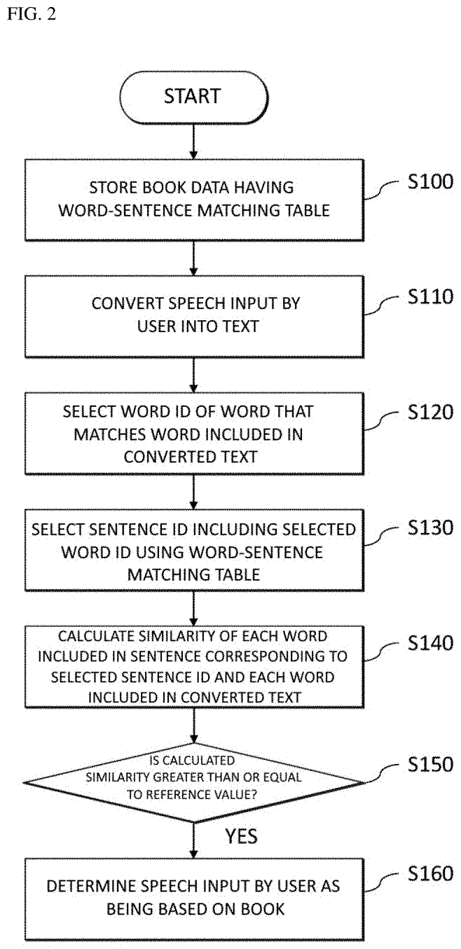

FIG. 2 is a schematic flowchart showing a method of determining the type of a user utterance according to the disclosure.

Referring to FIG. 2, in the method of determining the type of a user utterance according to the disclosure, in step S100, first, the processor may store book data having a word-sentence matching table. Since the book data having the word-sentence matching table has been described with reference to FIG. 1, redundant descriptions thereof will be omitted. The word-sentence matching table also includes weight values.

In step S110, the processor may convert speech input by a user into text. Since a speech-to-text technique is a technique generally known to those skilled in the art, detailed descriptions thereof are omitted.

In step S120, the processor may select a word ID of a word that matches with a word included in the converted text. In step S130, the processor may select a sentence ID of a sentence including the selected word ID using the word-sentence matching table.

In step S140, the processor may calculate a similarity between each word included in the sentence corresponding to the selected sentence ID and each word included in the converted text. The similarity is a probability value ranging from 0 to 1.

In step S150, the processor may determine whether the calculated similarity is greater than or equal to a preset reference value. In this case, when the calculated similarity is greater than or equal to the reference value (in step S160), the processor may determine that the speech input by the user has a content based on the book.

The method of determining the type of the user utterance according to the disclosure will be described again through example sentences and words. As an example, it is assumed that a book includes two sentences: “The boy is on the playground. The boy is Tom,” and a word-sentence matching table containing weight values is generated through the two sentences (S100).

As a question about reading evaluation, a question “Where is Tom?” is presented to the user, and the user presents an answer “There is boy in the playground.” (S110).

By a single transaction translator (STT) algorithm, the answer of the user may be divided into words “There,” “is,” “boy,” “in,” “play,” and “ground.” In this case, the division of “playground” into “play” and “ground” represents misrecognition that may commonly occur in the STT process. Thereafter, a word ID “W001” may be selected on the basis of the word “boy” (S120). Then, sentence IDs “S0001” and “S0002” corresponding to the word ID “W001” may be selected through the word-sentence matching table (S130).

The similarity between each word included in the sentences “S001: The boy is on the playground.” and “S002: The boy is Tom.” corresponding to the selected sentence IDs and each word “There,” “is,” “boy,” “in,” “play,” and “ground” included in the converted text may be calculated (S140). As an example, the similarity value of each word may be calculated using the “Sorensen-Dice coefficient.” In this case, the similarity value of each word may be obtained as the largest value among similarity values calculated by matching each word. However, it is apparent that the calculation of the similarity value is not limited to the “Sorensen-Dice coefficient” and may be calculated through various algorithms known to those skilled in the art.

Meanwhile, the processor may calculate the similarity to reflect the weight of each word included in the sentence.

According to an embodiment of the disclosure, the processor may calculate the similarity in comparison to the number of words included in the converted text. In more detail, the processor may calculate the similarity according to Equation 2 below.

$$similarity = \frac{\begin{matrix}\{ {\sum }_{i = 1}^{k} ( {i}^{th} word largest similariy value ) \times \\ ( {i}^{th} word weight ) \} \times ( number of words in utterace )\end{matrix}}{100} \qquad [ Equation 2 ]$$

i: the order of a word included in the converted text

k: the total number of words included in the converted text

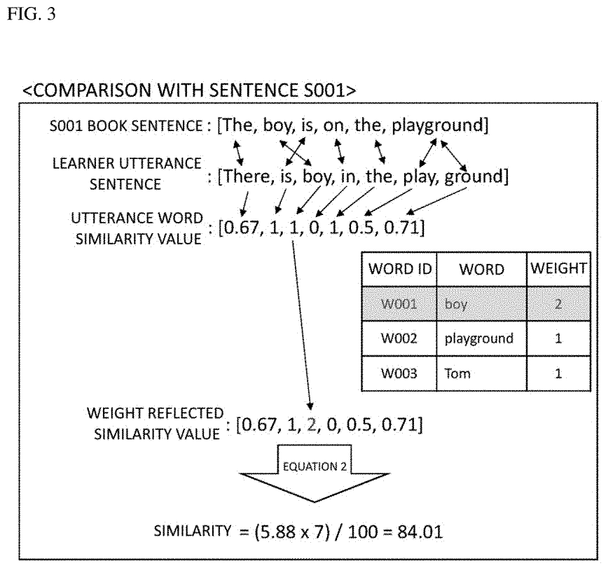

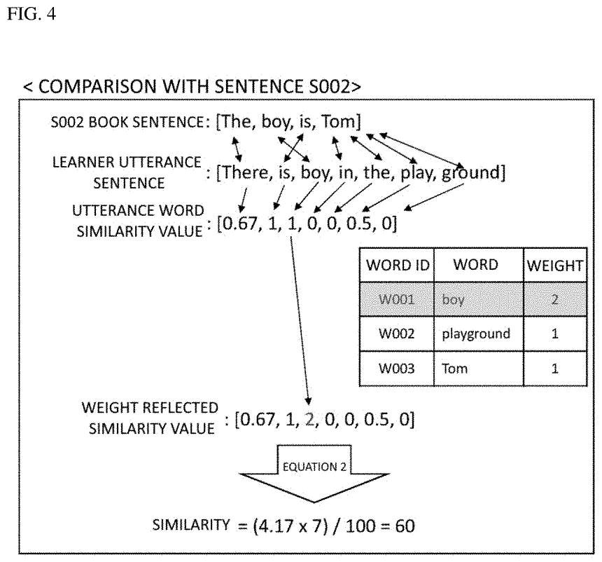

For the sake of convenience of understanding, the calculation of the similarity will be described with reference to FIGS. 3 and 4.

FIG. 3 is an example of comparing sentence S0001 with a user utterance, and FIG. 4 is an example of comparing sentence S0002 with a user utterance. Referring to FIGS. 3 and 4, the similarity between the user utterance and sentence S0001 is “84.01,” and the similarity between the user utterance and sentence S0002 is “60.” When assuming that the preset reference value is 70, the user utterance “There is boy in the playground.” may be determined to be based on sentence S0001. Therefore, the user who has provided an answer “There is boy in the playground.” to the question “Where is Tom?” for the reading evaluation may be determined as having correctly understood the contents of the book.

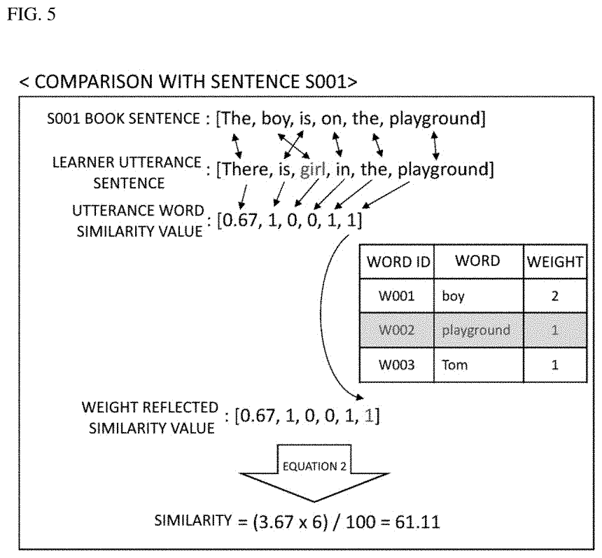

FIG. 5 is an exemplary diagram illustrating a case opposed to that shown in FIGS. 3 and 4.

Referring to FIG. 5, it can be seen that the user has provided an answer “There is girl in the playground.” In addition, in the example shown in FIG. 5, the STT algorithm sets a more beneficial situation as “playground” is accurately recognized. Still, since the user utterance does not include a word “boy” having a high weight, the similarity is calculated as 61.11. Therefore, a user who has provided an answer “There is girl on the playground,” to the question “Where is Tom?” for reading evaluation may be determined as having incorrectly understood the contents of the book.

Meanwhile, the method of determining the type of a user utterance according to the disclosure may, in a situation where a specific book is selected, determine whether the user utterance corresponds to the specific book. However, as mentioned above, the method of generating a book database according to the disclosure is not executed for only one book but may construct a database for a plurality of books. In general, since a number of books that are set with various levels of difficulty considering the user's age, foreign language ability, etc. are provided as a set to users who are learning a foreign language, it is not desirable to determine the matching of the user utterance particularly with a specific book.

A process in which a user having read several books develops ideas by connecting contents of a book read at a current time with content read from another book and expresses the thoughts in a foreign language may be of greater help in improving the foreign language learning ability. In a reading evaluation system that utilizes a natural language conversation algorithm, commonly called a chat-bot, there is a need to determine whether the user utterance concerns a book that has just been read, a book that has been previously read, or another book that has not yet been read but is included in the book set. When the user utterance concerns a book just read by the user, whether the user correctly understands the content of the book may be determined. When the user utterance concerns a previously read book, a review may be provided based on the similarities or differences between the book just read and the book previously read. When the user utterance concerns another book that has not yet been read, the book may be recommended. In this way, the reading evaluation system using the natural language conversation algorithm may generate natural sentences that follow the user utterance.

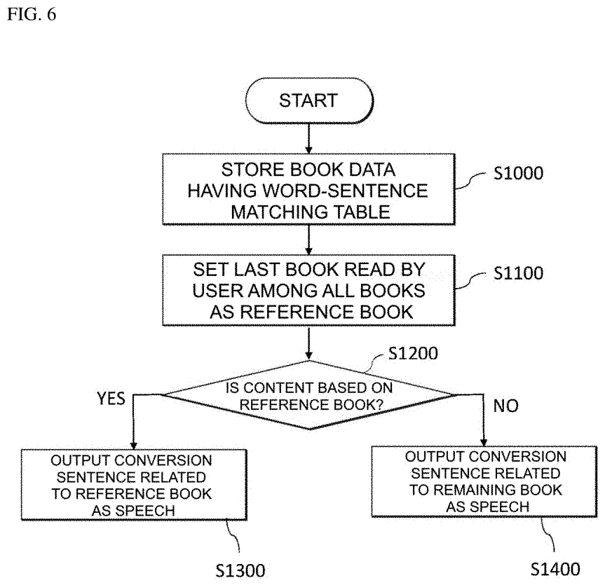

FIG. 6 is a schematic flowchart showing a method of generating a conversation sentence according to the disclosure.

Referring to FIG. 6, first, in step S1000, the processor may store a book database generated for each book. The book database may be a book database generated by the method of generating a book database described above with reference to FIG. 1. Therefore, redundant descriptions may be omitted.

In step S1100, the processor may set the last book read by the user among all the books as the reference book. In step S1200, the processor may convert speech input by a user into text. Since a speech-to-text technique is a technique generally known to those skilled in the art, detailed descriptions thereof are omitted.

In step S1200, the processor may determine whether the converted text has a content based on the reference book. Determination of whether the content of the converted text is based on the reference book may be performed according to steps S120 to S160 of the method of determining the type of a user utterance according to the disclosure described above.

When the converted text has a content based on the reference book (YES in S1200), the processor may output a conversation sentence related to the reference book as speech. On the other hand, when the converted text has a content based on the remaining books except for the reference book among all the books (NO in S1200), the processor may output a conversation sentence related to the remaining books as speech.

The “conversation sentences related to the reference book” may vary depending on which questions have been previously provided to the user and which questions are left. It may be assumed that the speech input by the user in step S1100 is an answer to a question for reading evaluation of the reference book.

According to an embodiment of the disclosure, in step S1300, the processor may output a result indicating whether the answer to the question for reading evaluation of the reference book is correct. In addition, when a question for reading evaluation of the reference book is still left, the processor may output another question for reading evaluation of the reference book as speech.

According to another embodiment of the disclosure, in step S1400, the process may treat the answer to the question for reading evaluation of the reference book as a wrong answer. In this case, the processor may further output speech indicating that the user's answer concerns another book. In addition, when a question for reading evaluation of the reference book is still left, the processor may output another question for reading evaluation of the reference book as speech. On the other hand, when all of the questions for reading evaluation of the reference book are output, the processor may output speech suggesting reading the remaining books in step S1300. In this case, the reference book may be reset to a new book.

Meanwhile, the user utterance, that is, the converted text, may not correspond to the content based on any one of the books including the reference book. In this case, the method further includes, by the processor, generating a sentence corresponding to the converted text through a preset website and outputting the generated sentence as speech. The preset website may be a search portal site, such as “www.google.com.” In addition, when the user is young, the preset website may be set to a child-only website suitable for the level of the user.

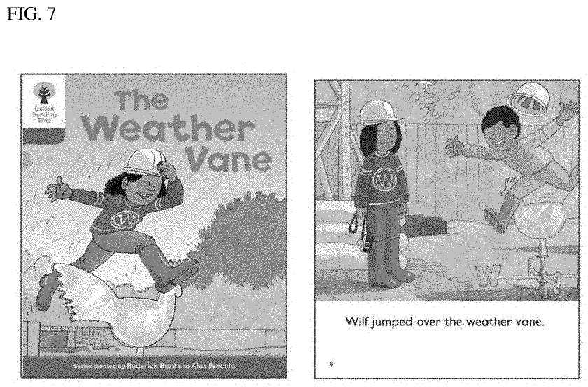

FIG. 7 is an exemplary diagram illustrating a reference book.

Referring to FIG. 7, a book titled “The Weather Vane” may be identified as a reference book. The content of the reference book includes a sentence “Wilf jumped over the weather vane”. A situation that a user has read the reference book, and speech “Did Wilf jump under the weather vane?” is output as a question for reading evaluation may be assumed. When the user has provided an answer “No, Wilf didn't.

He jumped over the weather vane,” the answer is treated as a correct answer because the answer is based on the reference book. In this case, the user may additionally provide a question “Who invented a weather vane?” In this case, an appropriate answer to the question is unlikely to exist in the book database. Accordingly, the processor may determine that the question does not correspond to the content based on any one of the books including the reference book and may provide a response such as, “The weather vane was invented by the Greek astronomer Andronicus in 48 B.C.,” through a website.

On the other hand, the above-description has been made in relation to a method of generating a book database based on text written in a book and determining and utilizing a user utterance using the generated database. However, the book may contain not only text but also illustrations. In particular, for younger users, the memory of the illustration image may remain stronger than the memory of the text. Accordingly, there may be a need for a process of adding data on the content of illustrations to the book database.

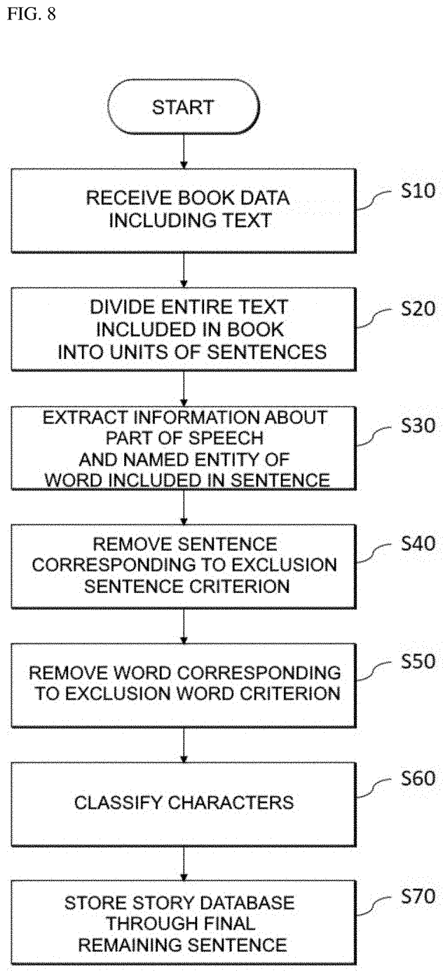

FIG. 8 is a schematic flowchart showing a method of generating a book database according to an embodiment of the disclosure.

Referring to FIG. 8, in the method of generating a book database for reading evaluation according to the disclosure, first, in step S10, the processor may receive book data including text. The method of generating a book database illustrated in FIG. 8 is a method of processing one book. However, the method of generating a book database according to the disclosure does not end with processing for only one book and may be executed for a plurality of books. For example, in response to a complete collection of one hundred English books for young users, the “book data” refers to the content of any one of the hundred books.

In step S20, the processor may divide the entire text included in the book into units of sentences. In step S30, the processor may extract part-of-speech information and named entity information of words included in each sentence. With the execution of step S30, a pronoun, such as “He, She, It, They” may be identified. According to an embodiment of the disclosure, in step S30, the pronoun may be replaced with a proper noun through coreference resolution for pronouns, and then named entity information may be extracted.

In step S40, the processor may remove a sentence corresponding to a preset exclusion sentence criterion. The exclusion sentence criterion may be set as various criteria to exclude sentences that do not significantly affect the story of the book.

According to an embodiment of the disclosure, step S40 may be a step of removing a sentence including a verb or auxiliary verb (e.g., want, like, can, will, need) indicating an opinion or possibility. For example, the following sentences may correspond to sentences to be excluded.

<“Biff didn't want to read it.” “Biff didn't like dragons.”>

According to another embodiment of the disclosure, step S40 may be a step of removing a sentence including a word indicating emotion. For example, the following sentences may correspond to sentences to be excluded.

<“Floppy was frightened.”>

According to still another embodiment of the disclosure, step S50 may be a step of removing, among two or more sentences in which the subject and the verb are the same and a sentence-to-sentence similarity is greater than or equal to a preset reference similarity value, the remaining sentences except for one sentence. For example, in response to the existence of sentences, <Floppy barked. Floppy barked and barked>, <Floppy barked> may correspond to a sentence to be excluded.

In step S50, the processor may remove a word corresponding to a preset exclusion word criterion in the remaining sentences. For example, in step S50, when the part of speech is a conjunction, preposition, interjection, adverb, or adjective, the processor may remove the corresponding word.

In step S60, characters may be classified according to a preset criterion among the remaining words in the remaining sentences. Further, in step S60, when a name identified through the named entity information appears in the final remaining sentences a preset number of times or more, the named entity may be set as a character. In particular, a main character in the book may be set as a character with the highest number of appearances, and the remaining characters may be set as auxiliary characters.

In step S70, a story sentence may be stored through the final remaining sentence. In this process, the final remaining sentences may be stored as a plurality of sentences without change or may be stored by combining the plurality of sentences to be re-produced as one sentence. As an example, when assuming ten final remaining sentences, the ten sentences may be stored as they are, the ten sentences may be re-produced and stored as five sentences, the ten sentences may be re-produced and stored as two sentences, or the ten sentences may be reproduced and stored as one sentence. In the process of combining and reproducing sentences, sentences with the same subject may be candidate sentences for combination-reproduction. The sentences becoming the candidate sentence for combination-reproduction due to having the same subject may be combined on the basis of the sameness/similarity of the verb.

For example, the content of a book may be assumed as follows.

<Biff woke up in the morning. Today is his birthday. He didn't want go to school. So he didn't go to school. He decided to go playground. He went to the playground. His family was preparing surprising party.>

Through steps S10 to S30, the book content may be converted into the following sentences.

<Biff woke up in the morning. Today is Biffs birthday. Biff didn't want go to school. So Biff didn't go to school. Biff decided to go playground. Biff went to the playground. Biffs family was preparing surprising party.>

Through step S40, some parts of the sentences may be deleted as follows.

<Biff woke up in the morning. Today is Biffs birthday. So Biff didn't go to school. Biff went to the playground. Biffs family was preparing surprising party.>

Through step S50, some of the words may be deleted as follows.

<Biff woke up in the morning. Today is Biffs birthday. [[so]] Biff didn't go to school. Biff went to the playground. Biffs family was preparing [[surprising]] party.>

Through step S60, the main character “Biff” and supporting characters “Biff's family” may be classified. All of the sentences above may be stored in the story sentence as they are. However, three final remaining sentences <“Biff woke up in the morning. Biff didn't go to school. Biff went to the playground.”> may be combined and reproduced. The subjects of the three sentences are the same, and the verbs of the three sentences, that is, woke/go/went, represent the actions of a person. Therefore, the three sentences above may be combined and reproduced as <“Biff woke up in the morning and didn't go to school but went to the playground.”>.

After the story sentence is generated through the above process, a story-related question may be generated to check whether the user has read and correctly understood the book. For example, questions about the characters in the book, and questions using sentences including the main characters may be provided using the character information. As an example of a question that questions understanding of the story, questions may be generated in the forms of i) What happened after <subject/character><verb>?, ii) What happened after <subject/noun other than character><verb>?, and iii) Why do you think <subject/character><verb>?. The above questions may be divided into an open question (a question without an answer) and a question questioning the understanding of the story (a question with an answer stored together) depending on the presence or absence of the answer. As an example of the open question, questions may be provided in the form of iv) What would you do if you <verb><object> like <subject/character>?, v) What would you do if you were <character> when <subject/character><verb> in <place>?.

On the other hand, the user may memorize the story only with the text of the book, but when the book contains illustration, the user may memorize the story through the image of the illustration. In particular, younger users may be more likely to remember stories through illustrated images. Accordingly, there is a need to reflect the content of the illustration in the story sentence.

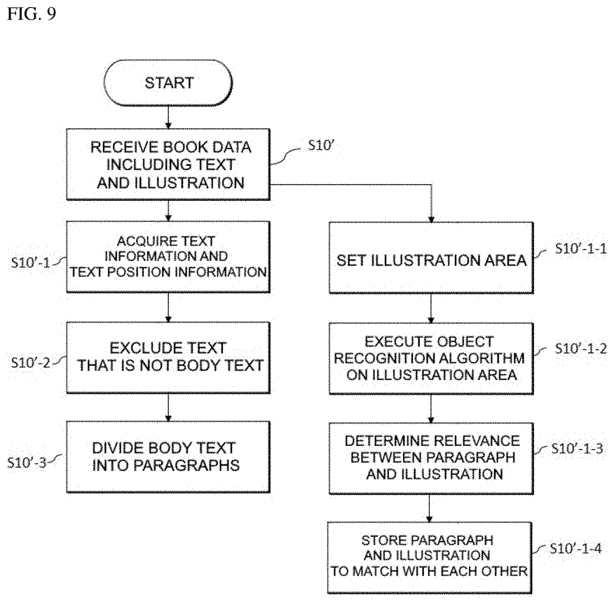

FIG. 9 is a schematic flowchart showing a method of generating a book database according to another embodiment of the disclosure.

Referring to FIG. 9, step S10′ is a step replacing step S10 to receive book data including “illustrations.” In addition, in step S10′-1, text information and text position information may be acquired through optical character recognition (OCR) analysis for each page. In step S10′-2, text (a page number, a publisher name, a book title, etc.) which is not a body text may be excluded using at least one of the text position, recognition accuracy, and text size. In step S10′-3, the body text may be divided into paragraphs using the position or size information of the body text. Sentences 1) having a text area at a uniform height, 2) having widths overlapping one on top of another by a certain percentage or more, and 3) having text areas vertically arranged at a distance less than a certain distance may be grouped into one paragraph. Additionally, sentence information (a text and an area) may be identified through natural language analysis of the body text, and paragraph summary may be performed through natural language processing for each paragraph. The reason why information in which the body text is divided not only into units of sentences but also into paragraphs is additionally generated is that illustrations in books are generally related to paragraphs of texts. A page containing an illustration is likely to concern a core content of a paragraph on the page. In particular, when two or more paragraphs are written on one page, the illustration is highly likely to be positioned close to a paragraph that is highly relevant to the core content.

Accordingly, after step S10′, in step S10′-1-1, an area in a region of a page where text is located, which does not overlap a text area and has a color contrasting with a background color, may be set as an illustration area. On the other hand, illustrations may be separately recognized in several sections on one page. In addition, as for consecutive pages that are viewed at a glance when the book is open, there is a possibility that illustrations are continued, so the possibility of merging with front/rear illustration areas is determined. Accordingly, when a plurality of illustration areas are set in step S10′-1-1, connectable illustrations among the set illustrations may be set as one illustration. The possibility of merging may be determined on the basis of the position, size, and color data of the illustration area.

In step S10′-1-2, an object recognition algorithm may be executed on the set illustration area to store an object name of the illustration. The object recognition algorithm is an algorithm composed of an artificial neural network that determines the type and content of an object in an image and may be implemented using an artificial neural network widely known at the time of filing of the disclosure.

In step S10′-1-3, the relevance between the paragraph and the illustration included in each page may be determined. According to an embodiment of the disclosure, the relevance may be determined according to the proximity between the illustration area and the sentence area. According to another embodiment of the disclosure, the relevance may be determined according to whether the illustration area and the sentence area have edges parallel to each other. According to another embodiment of the disclosure, the relevance may be determined according to whether a sentence contains a word that matches or approximates the object name of the illustration.

Next, in step S10′-1-4, when the relevance between the illustration and the paragraph satisfies a preset condition, the sentence or word included in the paragraph may be stored to match with the illustration. The matched sentence may be determined not to correspond to the exclusion sentence criterion in step S40 of FIG. 8. For example, even when a sentence expresses an emotion of a character, the sentence important enough to be expressed as an illustration may not need to be excluded. In addition, in order to identify the content of the illustration, not only the object recognition result but also information about the illustration through words included in the matched sentence may be stored.

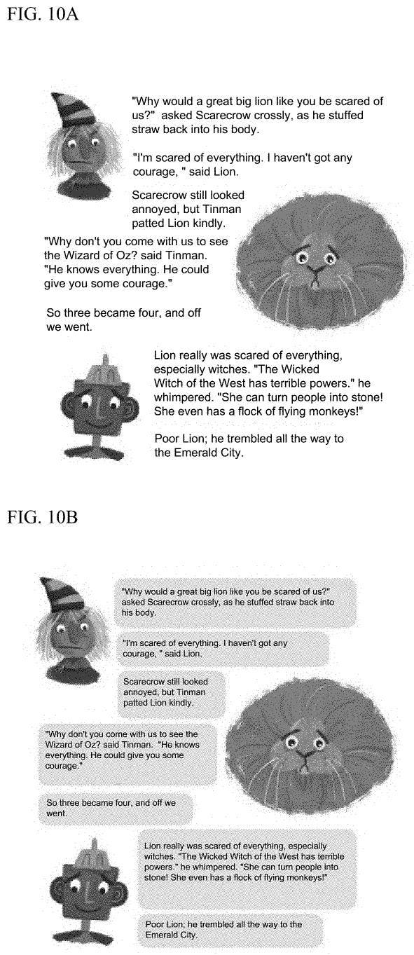

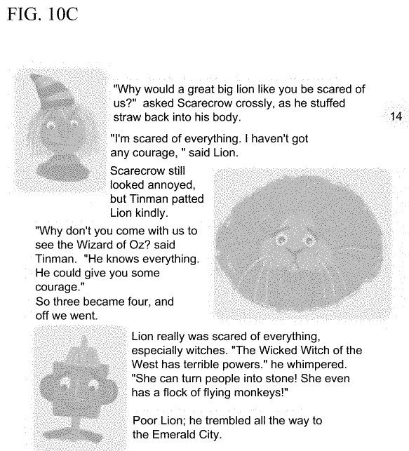

FIG. 10 shows reference diagrams for describing recognition of paragraph and illustration.

FIG. 10A is an example of book data including text and illustrations. For the sake of convenience of understanding, only one page is shown. FIG. 10B is an example of information about a paragraph in a page that is obtained through execution of steps S10′-1 to S10′-3. FIG. 10C is an example of information about an illustration that is obtained through execution of steps S10′-1-1 to S10′-1-4.

The processor may include a microprocessor, an application-specific integrated circuit (ASIC), another chipset, a logic circuit, a register, a communication modem, a data processing device, and the like that are known in the art to which the disclosure belongs in order to execute the above-described various calculations, determinations, and various control logic. In addition, the processor may be implemented as a set of program modules when the above-described method is implemented in software. In this case, the program module may be stored in the memory device and executed by the processor.

The program may include codes coded in a computer language, such as a machine language, e.g., C/C++, C#, JAVA, Python, which can be read by a processor (a central processing unit (CPU)) of a computer through a device interface of a computer in order for the computer to read the program and execute the methods implemented as the program. The code may include a functional code that is related to a function that defines functions needed to execute the methods and may include an execution procedure related control code needed to cause the processor of the computer to execute the functions according to a predetermined procedure. In addition, the code may further include a memory reference related code as to whether additional information or media needed to cause the processor of the computer to execute the functions should be referred to at a location (an address) of an internal or external memory of the computer. In addition, when the processor of the computer needs to communicate with any other computers or servers, etc. at a remote site, to perform the above-described functions, the code may further include communication related codes such as how to communicate with any other computers or servers at a remote site, and what information or media should be transmitted or received during communication.

The storage medium does not refer to a medium that stores data for a short period of time, such as a register, cache, memory, etc., but refers to a medium that stores data semi-permanently and can be read by a device. Specifically, examples of the storage medium include may include a read-only memory (ROM), a random-access memory (RAM), a compact disc (CD)-ROM, a magnetic tape, a floppy disk, an optical data storage device, etc., but are not limited thereto. That is, the program may be stored in various recording media on various servers to which the computer can access or on various recording media on the computer of the user. In addition, the medium may be distributed over computer systems connected through a network so that computer-readable codes may be stored in a distributed manner.

As is apparent from the above, a book database for reading evaluation is generated, thereby determining whether a user utterance is based on contents of a book and generating a conversation sentence using the book database for the user.

The effects of the disclosure are not limited to those described above, and other effects not mentioned above will be clearly understood by those skilled in the art from the above detailed description.

Although the disclosure has been described in detail above with reference to the exemplary embodiments, those of ordinary skill in the technical field to which the disclosure pertains should be able to understand that various modifications and alterations may be made without departing from the technical spirit or essential features of the disclosure. Therefore, it should be understood that the disclosed embodiments are not limiting but illustrative in all aspects.

What is claimed is:

1. A method of generating a book database for reading evaluation, the method, executed by a processor, comprising the steps of:
(a) receiving book data of a book including text;
(b) dividing the entire text included in the book into units of sentences;
(c) assigning the sentences with sentence identifiers (IDs) and storing the sentences assigned with the sentence IDs;
(e) dividing words included in each of the sentences assigned with the sentence IDs;
(f) assigning the words with word IDs and storing the words assigned with the word IDs such that the same words included in the book are assigned with the same word ID;
(g) generating and storing a table in which the word ID and the sentence ID match with each other, the table referred to as a word-sentence matching table; and
(h) calculating a weight of each of the words using the number of the sentences including the word and storing the weights of the respective words.

2. The method of claim 1, wherein the weight of each of the words increases proportionally as the number of the sentences including the word increases.

3. The method of claim 2, wherein the weights of the words are provided such that a largest weight is twice a smallest weight.

4. The method of claim 3, wherein in the step (h), the weight of each of the words is calculated through the following Equation:
$$weight = ( \frac{number of sentences including word}{\begin{matrix}number of sentences including \\ word used in most sentences\end{matrix}} ) + 1. \qquad [ Equation ]$$

5. The method of claim 1, wherein the step (e) includes excluding an article in each of the sentences.

6. The method of claim 1, wherein the step (b) includes:
(b-1) extracting information about a part of speech and information about a named entity of the words included in each of the sentences;
(b-2) removing sentences corresponding to a preset exclusion sentence criterion;
(b-3) removing words corresponding to a preset exclusion word criterion in sentences remaining after removing the sentences;
(b-4) classifying characters in words remaining after removing the words in the remaining sentences according to a preset criterion; and
(b-5) storing a story sentence through the final remaining sentence.

7. The method of claim 6, wherein the step (b-1) includes extracting the information related to the named entity after replacing a pronoun with a proper noun through a coreference resolution.

8. The method of claim 6, wherein the step (b-2) includes removing i) the sentence including a verb or an auxiliary verb indicating an opinion or a possibility, ii) the sentence including a word indicating an emotion, or iii), among two or more sentences having the same subject and the same verb and a sentence-to-sentence similarity that is greater than or equal to a preset reference similarity value, the remaining sentence except for one sentence.

9. The method of claim 6, wherein the step (b-3) includes removing a word that is a part of speech corresponding to a conjunction, a preposition, an interjection, an adverb, or an adjective.

10. The method of claim 1, wherein the book data is image data including text and an illustration, and
the step (a) further includes:
(a-1) acquiring text information and text position information through optical character recognition (OCR) analysis for each page;
(a-2) excluding text which is not a body text using at least one of a text position, a recognition accuracy, and a text size; and
(a-3) dividing the body text into paragraphs using information about the position or size of the body text.

11. The method of claim 10, wherein the step (a) includes:
(a-1-1) setting, in a region where the text in the page is located, an area that does not overlap a text area and has a color contrasting with a background color, as an illustration area;
(a-1-2) executing an object recognition algorithm on the set illustration area to store an object name of the illustration;
(a-1-3) determining a relevance between the paragraph and the illustration included in each page; and
(a-1-4) in response to the relevance between the illustration and the paragraph being satisfying a preset condition, storing the sentence or word included in the paragraph to match with the illustration.

12. The method of claim 11, wherein the step (a-1-3) includes:
determining the relevance according to a proximity of the illustration area and a sentence area;
determining the relevance according to whether the illustration area and the sentence area have edges parallel to each other, or
determining the relevance according to whether the sentence includes a word that matches or approximates the object name of the illustration.

13. A method of determining a type of a user utterance using a book database, the method, executed by a processor, comprising the steps of:
(a) storing the book database generated according to claim 1;
(b) converting speech input by a user into text;
(c) selecting a word ID that matches with a word included in the converted text;
(d) selecting a sentence ID including the selected word ID using the word-sentence matching table;
(e) calculating a similarity between each word included in a sentence corresponding to the selected sentence ID and each word included in the converted text to reflect the weight of each word included in the sentence; and
(f) determining that the speech input by the user has a content based on the book when the calculated similarity is greater than or equal to a preset reference value.

14. The method of claim 13, wherein the step (e) includes calculating the similarity according to the following Equation:
$$similarity = \frac{\begin{matrix}\{ {\sum }_{i = 1}^{k} ( {i}^{th} word largest similariy value ) \times \\ ( {i}^{th} word weight ) \} \times ( number of words in utterace )\end{matrix}}{100} , \qquad [ Equation ]$$
wherein i denotes an order of the words included in the converted text, and k denotes a total number of the words included in the converted text.

15. A method of generating a conversation sentence using a book database, the method, executed by a processor, comprising the steps of:
(a) storing a book database generated for each book according to claim 1;
(b) setting a last book read by a user among all the books as a reference book;
(c) converting speech input by a user into text;
(d) determining whether the converted text has a content based on the reference book by:
selecting a word ID that matches with a word included in the converted text;
selecting a sentence ID including the selected word ID using the word-sentence matching table;
calculating a similarity between each word included in a sentence corresponding to the selected sentence ID and each word included in the converted text to reflect the weight of each word included in the sentence; and
determining that the speech input by the user has a content based on the book when the calculated similarity is greater than or equal to a preset reference value; and
(e) when the converted text has a content based on the reference book, outputting a conversation sentence related to the reference book as speech and, when the converted text has a content based on the remaining book except for the reference book among all the books, outputting a conversation sentence related to the remaining book as speech.

16. The method of claim 15, wherein the speech input by the user in the step (c) is an answer to a question for reading evaluation of the reference book, and
the step (e) includes, when the converted text has a content based on the reference book, outputting a result indicating whether the answer to the question for reading evaluation of the reference book is a correct answer, or another question for reading evaluation of the reference book as speech.

17. The method of claim 15, wherein the speech input by the user in the step (c) is an answer to a question for reading evaluation of the reference book, and
the step (e) includes, when the converted text has a content based on the remaining book except for the reference book among all the books, treating the answer to the question for reading evaluation of the reference book as a wrong answer and outputting another question for reading evaluation of the reference book as speech.

18. The method of claim 15, wherein the speech input by the user in the step (c) is an answer to a question for reading evaluation of the reference book, and
the step (e) includes, when the converted text has a content based on the remaining book except for the reference book among all the books and all the questions for the reading evaluation of the reference book are output, outputting speech that suggests reading the remaining book.

19. The method of claim 18, wherein the step (e) further comprises, when the converted text does not correspond to content based on all the books including the reference book, generating a sentence corresponding to the converted text through a preset website and outputting the generated sentence as speech.

20. A computer program written to execute each of the steps in the method according to a claim 1 by a computer and recorded in a recording medium readable by the computer.
